(19) United States
(12) Patent Application Publication
(10) Pub. No.: US 2010/0206787 A1
(43) Pub. Date: Aug. 19, 2010

(54) CONTROL OF OXIDATION PROCESSES IN ULTRAVIOLET LIQUID TREATMENT SYSTEMS

(76) Inventors: Ytzhak Rozenberg, Ramat Gan (IL); Linoam Eliad, Modiin (IL); Uri Levy, Rehovot (IL)

Correspondence Address: Pearl Cohen Zedek Latzer, LLP, 1500 Broadway, 12th Floor, New York, NY, 10036, US

(21) Appl. No.: 12/678,715

(22) PCT Filed: Sep. 17, 2008
(86) PCT No.: PCT/IL08/01245

§ 371 Date: Mar. 17, 2010

Related U.S. Application Data
(60) Provisional application No. 60/960,123, filed on Sep. 17, 2007.

(51) Int. Cl. C02F 1/72; C02F 1/32; B01J 19/12

(52) U.S. Cl. 210/96.1

(57) ABSTRACT

Embodiments of the invention include a system and a method of monitoring in real-time, using a close loop feed-back configuration, the concentration of an active chemical substance, such as an oxidizing agent, in a water treatment system combining oxidation processes and enhanced by ultraviolet light.

### BACKGROUND OF INVENTION

Advanced oxidation processes (AOP) are used to treat liquids by decomposing hazardous toxic chemical compounds into nontoxic materials such as carbon dioxide (CO₂) and water without producing additional hazardous by-products or residues that require further handling. The term “advanced oxidation processes” refers specifically to processes in which oxidation of organic contaminants occurs primarily through reactions with hydroxyl radicals. These processes may combine ozone (O₃), hydrogen peroxide (H₂O₂), titanium dioxide and/or other oxidizing agents with ultraviolet (UV) light. The ozone molecules produce hydroxyl (.OH) radicals in the presence of UV light and water. Then, organic oxidation may occur due to the reaction of the organic compounds with the hydroxyl radicals. The concentration of the oxidizing agent, for example ozone, should be controlled and maintained within a certain range. A higher concentration would lead to reactions of the hydroxyl radicals between themselves and a lower concentration would lead to insufficient decomposition of the organic chemicals. Further, there is a need to control the concentration of the residual oxidizing agent in the liquid exciting the ultraviolet system.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a conceptual illustration of a liquid treatment system according to embodiments of the invention;

FIG. 2 is a conceptual illustration of liquid treatment system according to embodiments of the invention;

FIG. 3 is a conceptual illustration of an exemplary ultraviolet system incorporated in the liquid treatment systems of FIGS. 1 and 2 according to embodiments of the invention; and

FIG. 4 is a conceptual illustration of an exemplary ultraviolet system incorporated in the liquid treatment systems of FIGS. 1 and 2 according to embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Some demonstrative embodiments of the invention include a system and a method of monitoring in real-time, using a close loop feed-back configuration, the concentration of an active chemical substance, such as an oxidizing agent, in a water treatment system combining oxidation processes and enhanced by ultraviolet light. It has been found that UV transmittance of the liquid may be used as a measurement for monitoring the concentration of certain oxidizing agents in the liquid due to the fact that the addition of the oxidant reduces the UV transmittance of the liquid. According to embodiments of the invention, the monitoring is based on measurements of the UV liquid transmittance near the inlet and outlet of the UV system so as to derive the UV liquid transmittance that is attributed to the presence of the oxidant.

The method of monitoring such processes may be applicable to many applications, such as for example, controlling and monitoring ozone concentrations in an advance oxidation process combining ozone and ultraviolet light, controlling and monitoring UV light transmittance of the liquid as a measurement for the level of decomposition of organic matter, controlling and monitoring oxidation-reduction potential to control redox-oxidation reactions or colors changes initiated by peroxides or by the hydroxyl radicals generated in the process, controlling the pH where the process involves acid and basic reactions, controlling the concentration of a nitric oxide to control the formation of nitric oxide (NO.) radicals in the process involving rich-nitric oxide water and the like.

It should be understood by a person skilled in the art that for some application the illumination source may be other than UV source as certain application such as the formation of nitric oxide (NO.) radicals may be more suitable for illumination with illumination sources emitting light at shorter or longer wavelengths, not within the UV spectrum. Accordingly, although in the exemplary embodiments detailed below the illumination, a UV source is described, embodiments of the invention are not limited in this respect and are likewise applicable to other illumination sources emitting at any suitable range.

According to embodiments of the invention, the method of monitoring and controlling chemical concentration of substances in the liquid may be based on UV light transmittance measurements. UV light transmittance of the liquid may be referred to as Ultraviolet Water Transmission (UVT), commonly used in the UV industry, defined as the UV transmittance of a one-centimeter water column at a wavelength of 254 nm. The UV light transmission may then be correlated to a required overall UV dose (often measured in units of millijoules per square centimeter) generated by the UV system. The UV dose is a measure of the output power radiation of the UV source applied to a fixed volume of liquid.

The Advance oxidation process may include supplying an oxidizing agent such as ozone to a flowing liquid to be treated in a UV system before the liquid enters the UV system and illuminating the liquid in the UV system with ultraviolet light according to selected the operating parameters. According to embodiments of the invention, the monitoring method may include selecting and optimizing the operating parameters for the ultraviolet system such as power of the lamp or liquid capacity and adjusting the operating parameters based on real-time measurements of ultraviolet (UV) transmission and flow rate of the liquid to control chemical characteristics of the liquid, such as concentration \n of substances in the liquid, pH, Redox potential. Gas permeable membrane electrodes and others.

According to embodiments of the invention, the advance oxidation process may include controlling the intensity of the UV light to maintain UV dose within a selected range. By monitoring the transmittance of the liquid within a desired range, the efficiency of the oxidation process may be increased. For example, a controlled oxidation process may decompose more molecules of unwanted organic compounds within the liquid in less energy. Accordingly, the operating parameters of the process may be selected and adjusted to ensure an efficient advanced oxidation process.

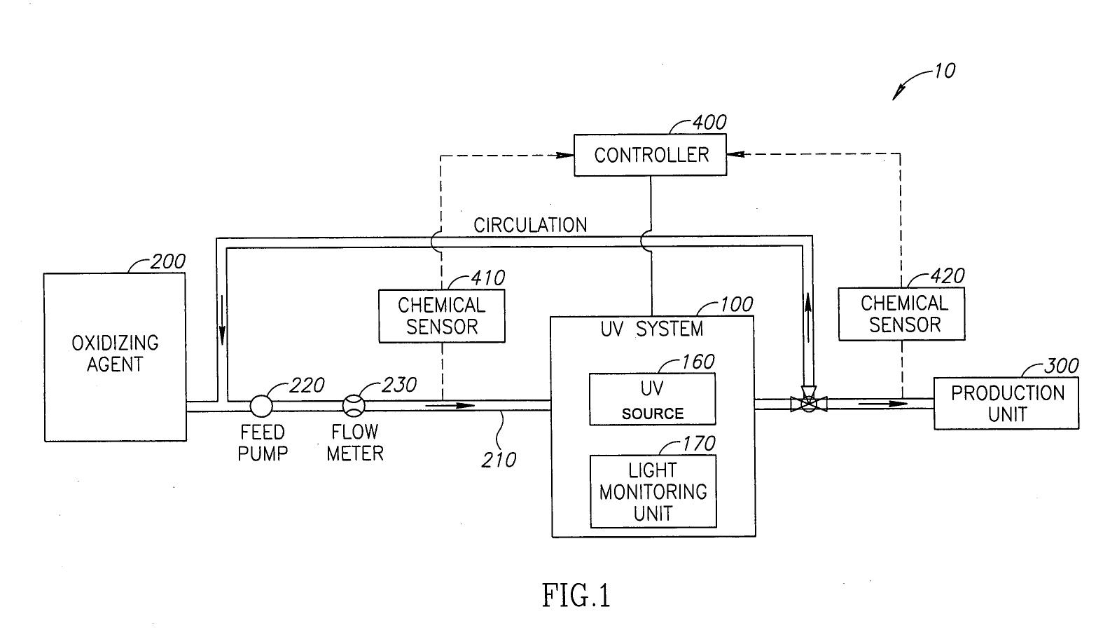

Reference is now made to FIG. 1, which illustrates a conceptual illustration of a liquid treatment system according to embodiments of the invention. A system 10 may include a UV system 100 having water transmission monitoring capabilities and an oxidant supply unit 200, located upstream to store an oxidizing agent, such as liquid enriched with ozone. UV system 100 and oxidant unit 200 may be operated together in an advanced oxidation process to treat liquid flow in pipes 210. UV system 100 may include at least one UV light source 160, such as medium pressure UV lamp and a UV light monitoring unit 170 to monitor the output power of the UV source 160. The system may be part of a production line and may supply the purified or uncontaminated liquid to a downstream production unit 300. System 10 may further include a feed pump 220 to deliver the oxidizing agent into UV system 100 and a flow meter 230 to monitor the flow rate of the liquid.

According to embodiments of the invention, further chemical agents used as photoactive catalysts, such as titanium dioxide (TiO₂) may be added to the liquid to generate a photocatalytic oxidation process. The photoactive catalysts may be immersed in an oxygenated aqueous solution and delivered to UV system 100 so that a redox environment is established, which causes the oxidation of organic compounds.

For ease of explanation, the description below will refer to an exemplary application of controlling the concentration of ozone. It should, however, be understood to a person skilled in the art, that this illustrative example is not intended to limit the scope of the invention in any manner. Accordingly, embodiments of the invention are likewise applicable to may other applications, as detailed above.

The advance oxidation process may be monitored on-line and the output power of the UV source may be adjusted in real-time to control the concentration of the OH radicals within the UV system to ensure decomposition of the organic material to an acceptable level and further to ensure that the residual ozone in the liquid that is delivered to production unit 300 is below a desired threshold. Accordingly, system 10 may further include a controller 400 and two ozone sensors, a first sensor 410 to measure the ozone concentration before the liquid enters UV system 100 and a second sensor 420 to measure the ozone concentration after the liquid exits UV system 100.

According to embodiments of the invention, controller 400, sensors 410 and 420 and light monitoring unit 170 of UV system 100 creates close feed back loop structure that enables the real-time monitoring. UV light monitoring unit 170 may include for each UV source 160, two sensors (not shown) located at different distances from the light source, one of which may be located in relative proximity to UV source 160. The sensor may measure the intensity of light at their location and the measurements from the sensors may be provided to controller 400 to calculate in real-time the UV light transmittance of the liquid.

The UV light transmittance of the liquid may be calculated in terms of Ultraviolet Water Transmission (UVT), commonly used in the UV industry, defined as the UV transmittance of a one-centimeter water column at a wavelength of 254 nm. The UV light transmission may then be correlated to a required overall UV dose, (often measured in units of millijoules per square centimeter) generated by the UV system

Controller 400 may further receive measurement results from ozone sensors 410, 420 and may adjust operating parameters of the UV system, such as the input power of the light source based on the results received from the ozone and the light sensors to monitor for example the concentration of the ozone in the liquid entering production unit 300 at an acceptable level below a desired threshold.

The desired ozone residual level in the liquid may be determined based on several parameters such as, requirements imposed by the specific application based for example on safety and health condition regulations, condition of the pipes and others. For example, in the food and beverage industry, the concentration level of ozone entering the UV system may be around 0.5 ppm and the concentration of the ozone in the liquid exiting UV system 100 and entering production unit 300 should be below 0.02-0.05 ppm.

Although in the exemplary embodiment ozone sensors are mentioned, it should be understood to a person skilled in the art that the invention is not limited in this respect and other chemical sensors, suitable for other processes, for example in the form of electrodes may be used. Non-exhaustive list of such sensors may include an Oxidation Reduction Potential (ORP) electrode (Redox meter) to control redox-oxidation reactions or colors changes initiated by peroxides or by the hydroxyl radicals generated within UV system 100, a PH electrode that may control a reaction that involved acid and basic reactions and a nitric oxide (NO) electrode to control the formation of NO. radicals within UV system 100 when the treated liquid is rich with nitric oxide. Other examples may include nepheometric turbidity unit (NTU) to control oxidation reaction of organic matter which absorb light in the Visible spectrum, a chlorine sensor for controlling free chlorine and total chlorine, for example, in swimming pools and Chlorine control destruction application Another embodiment of the invention may include using a Dissolvent Oxygen (DO) for reaction with formation oxygen or reducing by UV illumination.

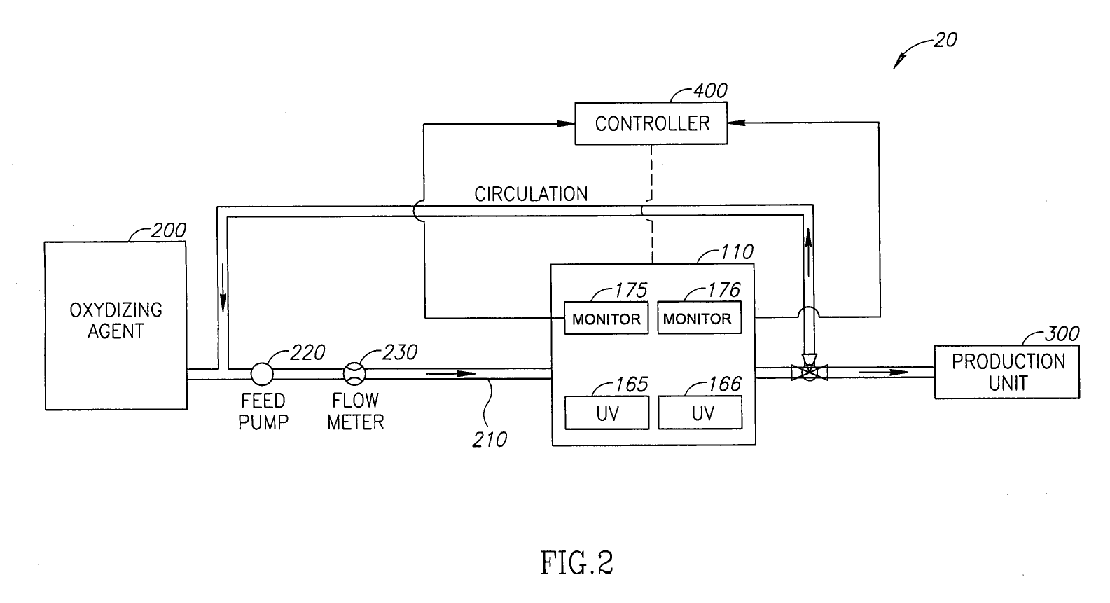

According to other embodiment of the invention, a method and system to monitor the advance oxidation process without directly measuring the concentration of the oxidant is enabled by comparing UVT measurements at two different locations within a conduit (not shown) of the UV system using the light monitoring and control units of the UV system. Reference is now made to FIG. 2, which illustrates a conceptual illustration of a liquid treatment system according to embodiments of the invention. A system 20 may include a UV system 110 having water transmission monitoring capabilities and oxidant supply unit 200, located upstream to store an oxidizing agent, such as liquid enriched with ozone. UV system 110 and oxidant unit 200 may be operated together in an advanced oxidation process to treat liquid flow in pipes 210. UV system 110 may include at least two UV light source 165 and 166 such as medium pressure UV lamp, each associated with a UV light monitoring unit 175 or 176 to monitor the output power of the its associated UV source. Light source 165 may be located in proximity to the liquid inlet of UV system and light source 166 may be located in proximity to the liquid outlet of the UV system. The system may be part of a production line and may supply the purified or uncontaminated liquid to downstream production unit 300. System 20 may further include feed pump 220 to deliver the oxidizing agent into UV system 100 and flow meter 230 to monitor the flow rate of the liquid, as in system 10 of FIG. 1.

The advance oxidation process may be monitored on-line and the output power of the UV source may be adjusted in real-time to control the concentration of the OH radicals within the UV system to ensure decomposition of the organic material to an acceptable level and further to ensure that the concentration of certain chemicals in the liquid such as ozone or other chemicals in the liquid delivered to production unit 300 is below a desired threshold. Accordingly, system 20 may further include controller 400, similar to the controller 400 of system 10 of FIG. 1. According to embodiments of the invention, controller 400 and light monitoring units 175 and 176 of UV system 100 creates close loop feed back structure that enables the real-time monitoring. Each of UV light monitoring units 175, 176 may include two sensors (not shown) located at different distances from their respective light source 165 or 166.

Each sensor may measure the intensity at the location of the sensor of light emitted from the respective UV source light. The measurements from the sensors may be provided to controller 400 to calculate in real-time the UV light transmittance of the liquid or the UV water transmission (UVT) values. The UV dose may be calculated periodically using the UVT values and other parameters including the flow rate of the liquid. Controller 400 may store data correlating between UV dose values and concentration of OH radicals or other desired chemical substances. If the calculated UV dose values are not within a required range that corresponds to a desired concentration, controller 400 may adjust operating parameters of UV system 100, such as the input power of the light source based on the calculated UV dose values or the results received, from the light sensors and the stored data in order to monitor concentrations of OH radicals, ozone molecules or other chemical substances relevant to the particular advanced oxidation process being carried out in the system. Controller 400 may adjust additional operating parameters of the system including for example water capacity or flow. Additionally, controller 400 may send an alert notification to a human operator.

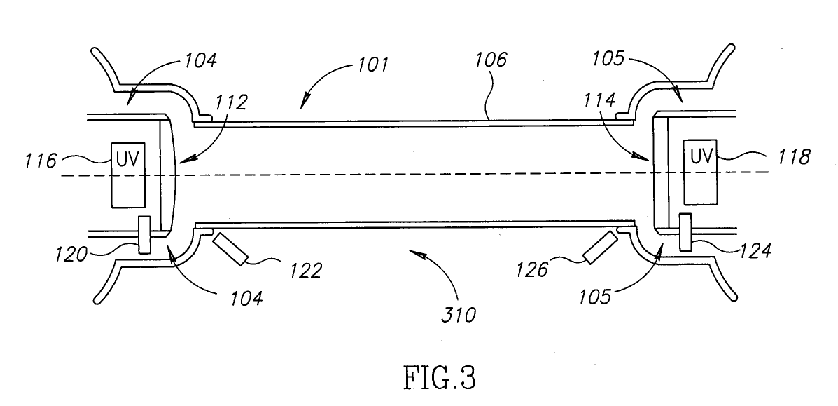

Reference is now made to FIG. 3, which is an exemplary illustration of the UV system used in an advance oxidation process system according to embodiments of the invention. Such a system, for example system 100 of FIG. 1 or system 110 of FIG. 2 may include a conduit with transparent walls and two UV sources located outside the conduit at two ends of the conduit, each proximate to a respective transmitive window. An exemplary system applicable to embodiments of the invention is for example, a system marketed as Model No. R200DL/SL, manufactured by Atlantium Technologies Ltd. of Har-Tuv, Israel.

According to some demonstrative embodiments of the invention, a system 310 may include a conduit 101 to carry a flowing liquid to be disinfected. Conduit 101 may have an inlet 104 to receive the liquid, and an outlet 105 to discharge the liquid. Conduit 101 may further include walls 106 which may be made of transparent material, such as quartz, and two UV-transparent windows located at opposite ends of conduit 101, a first window 112 located in proximity to inlet 104 and a second window 114 located in proximity to outlet 105. System 310 may further include a first external UV source 116 located in proximity to UV transparent window 112 and a second external UV source 118 located in proximity to UV transparent window 114.

The light produced by UV sources 116, 118 may be directed toward the liquid within conduit 101 via UV-transparent windows 112, 114, respectively. The windows may be made of quartz. Any other suitable UV-transparent material may be used. According to other embodiments of the present invention, system 310, when installed in system 10 of FIG. 1 may include only one UV source.

According to embodiments of the invention, UV system 310 may include a first light sensor 120 that may serve as a lamp status detector of UV source 116 and a second light sensor 122 to measure the light intensity of UV source 116 at a larger distance. First light sensor 120 detects light emitted from the UV source directly as the detected light has not traversed through the liquid. The second light sensor 122 detects light emitted from the UV source 116 after it traverses through the liquid and may serve as a water transmission detector. The measurements from light detectors 120 and 122 may enable on-line real-time measurements of UV light transmittance of the liquid.

UV system 310 may include a similar light sensor to measure the output power of the second UV source 118. Accordingly, the system may further include a third light sensor 124 that may serve as a lamp status detector of UV source 118 and a second light sensor 126 to measure the light intensity of UV source 118 at a larger distance. First light sensor 124 detects light emitted from the UV source directly as the detected light has not traversed through the liquid. The second light sensor 126 detects light emitted from the UV source 118 after it traverses through the liquid and may serve as a water transmission detector. The measurements from light detectors 120, 122, 124 and 126 may enable on-line real-time comparison of UV light transmittance of the liquid at the upstream area of the conduit, near the inlet and UV light transmittance of the liquid at the downstream area of the conduit, near the outlet. According to embodiment of the invention these measurements may be used as a feed-back for monitoring advance oxidation processes and controlling of concentration of oxidant by adjusting operating parameters such as the input power of the UV sources.

During the advance oxidation process, the power of light emitted from UV sources 116, 118 may be measured. The measurement results may be provided to controller 400 of FIGS. 1 and/or 2 to be used for calculating real-time UV water transmission (UVT) values. Using the UVT values and other parameters including the flow rate of the liquid, the UV dose may be calculated periodically.

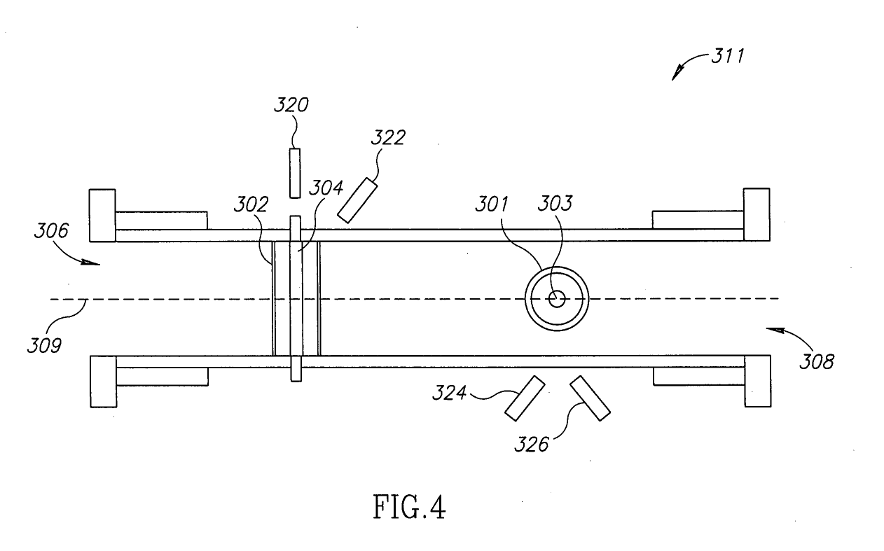

Reference is now made to FIG. 4, which is an exemplary illustration of the UV system used in an advance oxidation process system according to embodiments of the invention. Such a system, for example system 100 of FIG. 1 or system 110 of FIG. 2 may include a conduit with transparent walls and at least one UV source located inside the conduit in a transimmisive sleeve perpendicular to the direction of flow of the liquid, such as for example, RZ104-xy, manufactured by Atlantium Technologies Ltd. OF Har-Tuv, Israel.

An exemplary system 311 may include a conduit 301 made of substantially UV-transparent glass, such as quartz to carry liquid to be disinfected. System 311 may further include two UV-transparent sleeves 301, 302 positioned within conduit 301 substantially perpendicular to its longitudinal axis of symmetry or the direction of flow of the liquid and further perpendicular to each other. A non-exhaustive list of suitable UV-transparent materials for the sleeve may be quartz or Teflon. It should be understood that embodiments of the invention are not limited to two UV sources and there may be any suitable number of UV sources positioned at any desired angle relative to each other. Both ends of each sleeve may extend from the walls of the conduit to enable the insertion of a UV source 303 within sleeve 301 and the insertion of a UV source 304 within sleeve 302. UV sources 303, 304 may illuminate the liquid to be disinfected when flowing in the conduit. Conduit 301 may have an inlet 306 to receive the liquid to be disinfected and an outlet 308 to discharge the liquid. In this configuration described in which the UV source is positioned substantially perpendicular to the longitudinal axis of symmetry 309 of conduit 301 and to the direction of flow of the liquid, the liquid may act as a waveguide and at least part of the radiation may be totally-internally reflected at the interface of the glass conduit and air surrounding it.

According to embodiments of the invention, UV system 311 may include a first light sensor 320 that may serve as a lamp status detector of UV source 304 and a second light sensor 322 to measure the light intensity of UV source 304 at a larger distance. First light sensor 304 detects light emitted from the UV source directly as the detected light has not traversed through the liquid. The second light sensor 322 detects light emitted from the UV source after it traverses through the liquid and may serve as a water transmission detector. The measurements from light detectors 320 and 322 may enable on-line real-time measurements of UV light transmittance of the liquid. The UV light transmittance of the liquid may be calculated in terms of Ultraviolet Water Transmission (UVT), commonly used in the UV industry, defined as the UV transmittance of a one-centimeter water column at a wavelength of 254 nm.

UV system 311 may include similar light sensor to measure the output power of the second UV source 303. Accordingly, the system may further include a third light sensor 324 that may serve as a lamp status detector of UV source 303 and a second light sensor 326 to measure the light intensity of UV source 303 at a larger distance. First light sensor 324 detects light emitted from the UV source directly as the detected light has not traversed through the liquid. The second light sensor 326 detects light emitted from the UV source after it traverses through the liquid and may serve as a water transmission detector. The measurements from light detectors 320, 322, 324 and 326 may enable on-line real-time comparison of UV light transmittance of the liquid at the upstream area of the conduit, near the inlet and UV light transmittance of the liquid at the downstream area of the conduit, near the outlet. According to embodiment of the invention these measurements may be uses as a feed-back for monitoring advance oxidation processes and controlling of concentration of oxidant by adjusting operating parameters such as the input power of the UV sources.

During the advance oxidation process, the power of light emitted from UV sources 304, 303 may be measured. The measurement results may be provided to controller 400 to be used for calculating real-time UV water transmission (UVT) values. Using the UVT values and other parameters including the flow rate of the liquid, the UV dose may be calculated periodically.

In both systems, system 310 of FIG. 3 and 311 of FIG. 4, the liquid within the conduit may act as a waveguide and at least part of the light emitted from the UV light source may be totally-internally reflected at the interface of the conduit and the air surrounding it. These systems are designed to generate substantially uniform or homogenous dose distribution throughout the conduit carrying the flowing liquid. The uniform dose distribution enables substantially uniform distribution of OH radicals in areas of the conduit to ensure that all the liquid flowing in the conduit will be exposed to a certain concentration level of OH radicals at least for a portion of the time when its traverses through the conduit. Ensuring a saturated level of OH radicals in a cross sectional area of the conduit perpendicular to the direction of flow may increase the efficiency of the decomposition of the organic compounds as it ensures that the stream of liquid flowing in the conduit would flow through a saturated zone where the OH radical is in the saturated level. It should be understood to a person of ordinary skill in the art that embodiments of the invention are not limited in this respect and any other UV system capable of emitting light at a uniform UV dose above a desired level may be used and having light monitoring capabilities may be used.

According to embodiments of the invention, both systems, system 310 of FIGS. 3 and 311 of FIG. 4, may be capable of emitting UV is such a way as to produce a narrow dose distribution, defined as the average UV dose minus the minimum UV dose divided by the average UV dose. According to embodiments of the invention, the UV dose distribution may be less than 0.5.

According to embodiments of the invention, the average velocity of the liquid flowing through system 100 may be equal or above approximately 0.25 meter/second. System 100 and conduits 101, 301 may have relatively small cross-sectional dimensions. For example, the smallest cross-sectional plane dimension of the conduit, essentially transverse to the liquid flow direction may be less then 20 cm. Therefore, if the cross-section plane of the conduit is circular, than the diameter of the conduit may not exceed approximately 20 cm.

Following is a description of an exemplary experiment that was conducted in order to assess the correlation between water transparency (in percents) and concentrations of Oxonia (H₂O₂ and peracetic acid—PAA, in ppm). Specifically, the transparency of the liquid before and after UV illumination was measured by absorbance spectra of the water in the inlet and the outlet of a UV conduit at 200-300 nm. Table 1 below, shows the correlation between water transparency (in percents) and concentrations of Oxonia (H₂O₂ and peracetic acid—PAA, in ppm) in the water samples.

TABLE 1

| Concentration of H₂O₂ and | |
|---|---|
| peracetic acid (PAA) in ppm | Water transparency |
| 123 (H₂O₂) + 387 (PAA) | 82% |
| 106 (H₂O₂) + 356 (PAA) | 84% |
| 72 (H₂O₂) + 237 (PAA) | 89% |
| 51 (H₂O₂) + 196 (PAA) | 92% |

These results clearly show that water transparency is in correlation with the concentration of H₂O₂ and PAA and that monitoring the water transparency provides an indication to the concentration of these agents in the water.

A further experiment was conducted in order to determine the effect of flow rate on the degradation process by UV light of Oxonia (H₂O₂ and peracetic acid—PAA) in a UV system as flow rate of the water reflects the UV light dose in a linear correlation. The effect of the flow rate on the degradation of Oxonia was measured in a UV system marketed as Model No. R200DL/SL, manufactured by Atlantium Technologies Ltd. of Har-Tuv, Israel. The specification of the system is as follows: optical path length of 75 cm; two lamps, each at 8.4 kW; flow rates of 12.2, 4.3 and 1.5 m³/hour. The H₂O₂ and PAA concentrations were determined by titrations and the Absorbance spectra of the inlet and the outlet solutions were measured at 200-300 nm. It has been found that for a flow rate of 4.3 m3/hour, by correlation between the outlet and the inlet concentrations of H₂O₂ and PAA that the H₂O₂ has much higher absorption coefficients at 200-300 nm than the PAA and that concentrations in the inlet are much higher than those in the outlet. Therefore, the PAA degradation proceeds mainly by its reaction with the hydroxyl radical produced by the H₂O₂ and the UV light. A linear correlation was also observed between flow rate of the water and Oxonia removal for all initial Oxonia concentrations, that the Oxonia removal is a function of a decrease in the water flow rate. In Summary, the degradation of Oxonia as a function of the flow rate was studied in dynamic experiments. The influence of flow rate is related to the exposure time of Oxonia to the light. Lower flow rate increases the exposure time and thus a higher dose of light is absorbed.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

What is claimed is:

1. A liquid treatment system comprising:
an oxidizing agent unit;
an ultraviolet system having a light monitoring unit;
a first chemical sensor to measure a chemical characteristic of liquid flowing between the oxidizing agent unit and the UV system;
a second chemical sensor to measure a chemical characteristic of liquid exiting the UV system; and
a controller to receive measurement data from the light monitoring unit, the first chemical sensor and the second chemical sensor,
wherein the controller, the light monitoring unit, the first chemical sensor and the second chemical sensor form a close-loop feed-back configuration that enables monitoring of an advance oxidation process.

2. The system of claim 1, wherein the first chemical sensor and the second chemical sensor are ozone sensors measuring the concentration of ozone in the liquid.

3. The system of claim 1, wherein the controller adjusts operating parameters of the UV system to affect UV dose values.
